(19) United States
(12) Patent Application Publication
(10) Pub. No.: US 2009/0217635 A1
(43) Pub. Date: Sep. 3, 2009

(54) DEVICE FOR ELIMINATING DUST FROM DUST-LADEN AIR, PARTICULARLY FOR USE IN A VACUUM CLEANER

(75) Inventors: Andre Bertram, Bielefeld (DE); Joerg Kinnius, Spenge (DE); Stefan Tiekoetter, Bielefeld (DE); Cornelius Wolf, Bielefed (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 12/442,916

(22) PCT Filed: Sep. 10, 2007
(86) PCT No.: PCT/EP07/07856

§ 371 Date: Mar. 25, 2009

(30) Foreign Application Priority Data
Sep. 28, 2006 (DE) 10 2006 046 328.5

(51) Int. Cl. B01D 45/12

(52) U.S. Cl. 55/428; 55/442

(57) ABSTRACT

A device for separating dust from dust-laden air. The device includes a first cyclone separator having an inlet portion with a tangential inlet. An axial inlet cyclone separator is disposed downstream of the first cyclone separator. The axial inlet cyclone separator has an air inlet disposed within the first cyclone separator. The axial air inlet includes a widening tubular section in the shape of a funnel extending into the inlet portion of the first cyclone separator.

### CROSS REFERENCE TO RELATED APPLICATIONS

This application is a U.S. National Phase application under 35 U.S.C. § 371 of International Application No. PCT/EP2007/007856, filed on Sep. 10, 2007, and claims benefit to German Patent Application No. DE 10 2006 046 328.5, filed on Sep. 28, 2006. The International Application was published in German on Apr. 3, 2008 as WO 2008/037342 A2 under PCT Article 21 (2).

### FIELD

The present invention relates to a device for separating dust from dust-laden air.

### BACKGROUND

Vacuum cleaners, in particular canister vacuum cleaners, use dust retention systems which are generally disposed between the air inlet of a dust collection chamber and the suction side of a fan and which retain the collected dust before it enters the fan. The best-known variant is a filter which is in the form of a bag and which is internally loaded, i.e., dust accumulates inside the bag. Generally, a fine dust filter is disposed downstream of the bag, said fine dust filter collecting dust particles which have a size of less than 2 μm and which have passed through the bag. As the number of allergic persons increases, it is increasingly important to remove this dust fraction from the ambient air because such particles are respirable because of their small size and, therefore, may have adverse effects on health. When the maximum collection capacity of about 400 grams is reached, the bag needs to be replaced. In the case of sealable bags in particular, this can be done in a hygienic manner, since the dust remains in the bag and is disposed of therewith. Depending on usage, replacement is required several times a year, which generates costs. The fine dust filter also needs to be replaced after a certain period of use, but the intervals are longer here because of the small amount of fine dust. Manufacturers recommend replacement after about one year. Due to the small particle sizes, the mass fraction of fine dust produced is small and, therefore, commercial fine dust filters have a capacity of about 10 grams.

Some mini vacuum cleaners, multipurpose vacuum cleaners, or industrial appliances use externally loaded filters, which enclose the fan. This can provide higher collection capacity. On the other hand, the filters of such vacuum cleaners are typically designed only for coarse dust. The fine dust, which contains allergenic pollens and microorganisms, passes through the filter and is blown back into the room by the fan, and is even stirred up in this process.

There is a desire for a filter system for coarse dust that can be reused and has the following features:
a compact design;
hygienic removal of the collected dust;
low losses in suction power.

DE 199 11 331 C1 describes a system with washably and reusable textile filter bags. However, there are concerns with such bags, primarily with regard to hygiene, because the heavily soiled bags must first be manually emptied and then washed in a washing machine.

EP 1 179 312 A2 describes a filter including dust cartridges that are made of porous sintered material.

EP 0 647 114 B1 describes a filter system with centrifugal separators or “cyclone separators.”

PCT/EP2006/008252 describes a system including inertial separators.

The latter three systems described above allow the dust collection container to be easily removed, emptied, and cleaned if soiled. Conventional systems, in particular cyclone separators, attempt to simulate the dust separation known from dust bags. For this reason, the cut size of the separators is very small. Therefore, the dust collection containers contain large quantities of respirable fine dust. As a result of this, during emptying of such containers, the lighter fractions of the dust being removed fly up and are dispersed in the air. This may have adverse effects, especially on people with allergies.

In order to avoid this, document PCT/EP2006/008252 describes a dust separation system which allows the dust to be separated into three fractions, the cut points being at dust particle sizes of 200 μm (first stage) and at 30 μm (second stage). In an embodiment, a dust-binding agent is added to the second fraction, which contains mainly dust particles having a size of between 30 μm and 200 μm. In this connection, it may be advantageous for the air in the collection container containing this second fraction to be swirled along a directional path so as to mix the dust particles with the dust-binding agent. In the dust collection container of the above-described inertial separator, no such swirling of air takes place.

Cyclone separators can include several tangential inlet separators connected in series, the first cyclone serving to separate out larger particles, and the downstream cyclones being used to perform further filtering. Examples of these are described in EP 0 018 197 A1, EP 0 042 723 A1, and in EP 0 489 565 A1. Due to the high separation efficiency of tangential separators, dust having particle sizes of about 1 μm is introduced in relatively large amounts into the second fraction. Such small particles are respirable and may pose a risk to the user's health during emptying. This is especially true for users with allergies.

British document GB 23 26 360 A describes a combination of two cyclone separators which are coupled in series and the second of which is funnel-shaped. The funnel-shaped configuration serves to increase the swirl and, thus, the velocity of the air. Because of this, this cyclone imparts a high centrifugal force on the particles, thus achieving an extremely low cut point, as a result of which respirable fine dust also accumulates in the second separator.

German document DE 101 32 690 A1 describes a separator device in which, first, an axial separator having deflector means is used. A funnel-shaped tangential separator is connected to and downstream of the axial separator. Here, again, a high centrifugal force and a correspondingly low cut size are obtained for the dust particles.

German document DE 697 12 046 T2 describes a household vacuum cleaner, in which an axial separator is connected to and downstream of a tangential separator. The axial separator has an air inlet containing a labyrinth-like structure and a swirl device disposed downstream thereof. It is possible for fibers and hairs to get caught in the vanes of this swirl device, thus impeding the entry of air. Moreover, such a separator is difficult to manufacture.

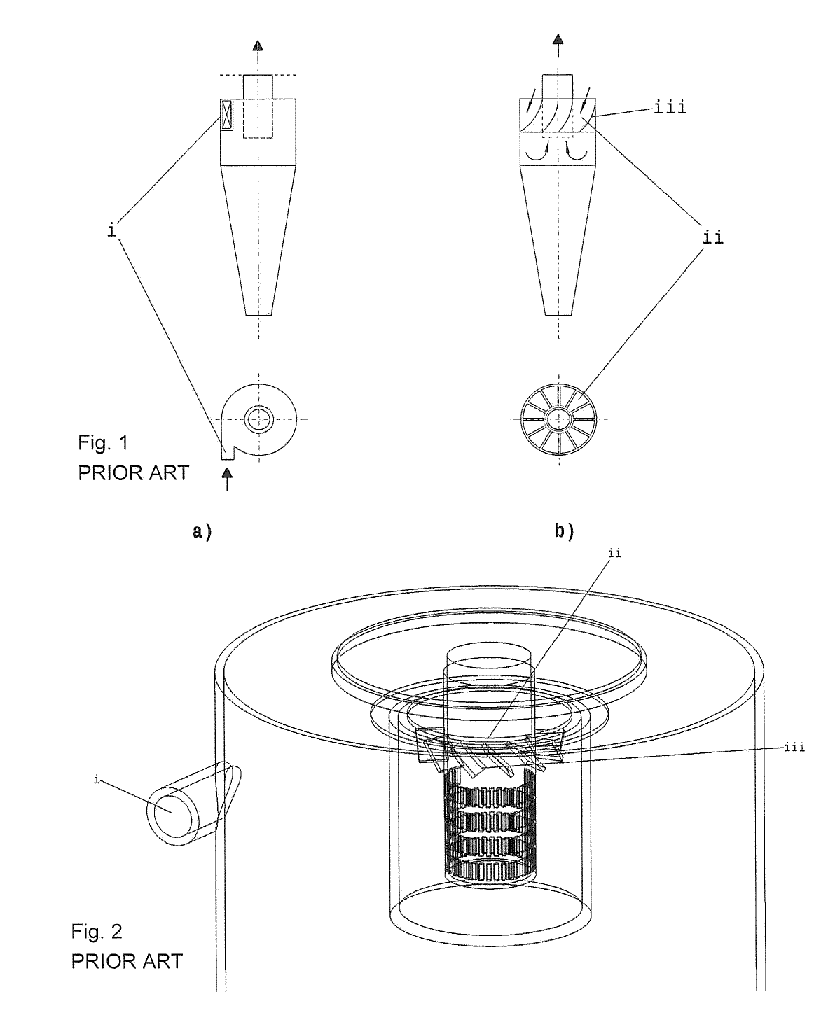

In industrial processing, separators known as axial separators (FIG. 1, detail b) are frequently used in addition to tangential separators (FIG. 1, detail a). In a tangential separator, the necessary swirl is produced because of the off-center radial position of air inlet (i). An axial separator, by definition, has an axial air inlet (ii) and, generally, uses vanes (iii) to produce a swirl. Due to the larger inlet cross-section, axial separators are capable of handling high volume flow rates in spite of their compact design. This makes them particularly interesting for vacuum cleaner applications. However, larger particles, hairs and fibers may get caught in vanes (iii). Therefore, it may be convenient that the coarse particles be separated by a tangential separator, and that only particles smaller than about 200 μm be delivered to an axial cyclone. FIG. 2 shows the basic design of such a combination of separators fluidically coupled in series. Although larger particles are thereby kept away from vanes (iii), it is still possible for fibers and hairs to enter. This would force the user to painstakingly clean vanes (iii) on a regular basis.

### SUMMARY

An aspect of the present invention is to provide a device for separating dust from dust-laden air, in particular for use in a vacuum cleaner, which is simple in construction and yet effective in operation.

In an embodiment, the present invention provides a device for separating dust from dust-laden air. The device includes a tangential cyclone separator having an inlet portion with a tangential inlet. An axial cyclone separator is disposed downstream of the first cyclone separator. The axial cyclone separator has an axial air inlet disposed within the tangential cyclone separator. The axial air inlet includes a widening tubular section in the shape of a funnel extending into the inlet portion of the tangential cyclone separator.

### DETAILED DESCRIPTION OF THE DRAWINGS

An exemplary embodiment of the present invention will be described in more detail in the following, and is schematically shown in the drawings, in which:

FIG. 1 is a schematic diagram showing a tangential separator and an axial separator, according to the prior art;

FIG. 2 is a view showing a combination of a tangential separator and an axial separator, according to the prior art;

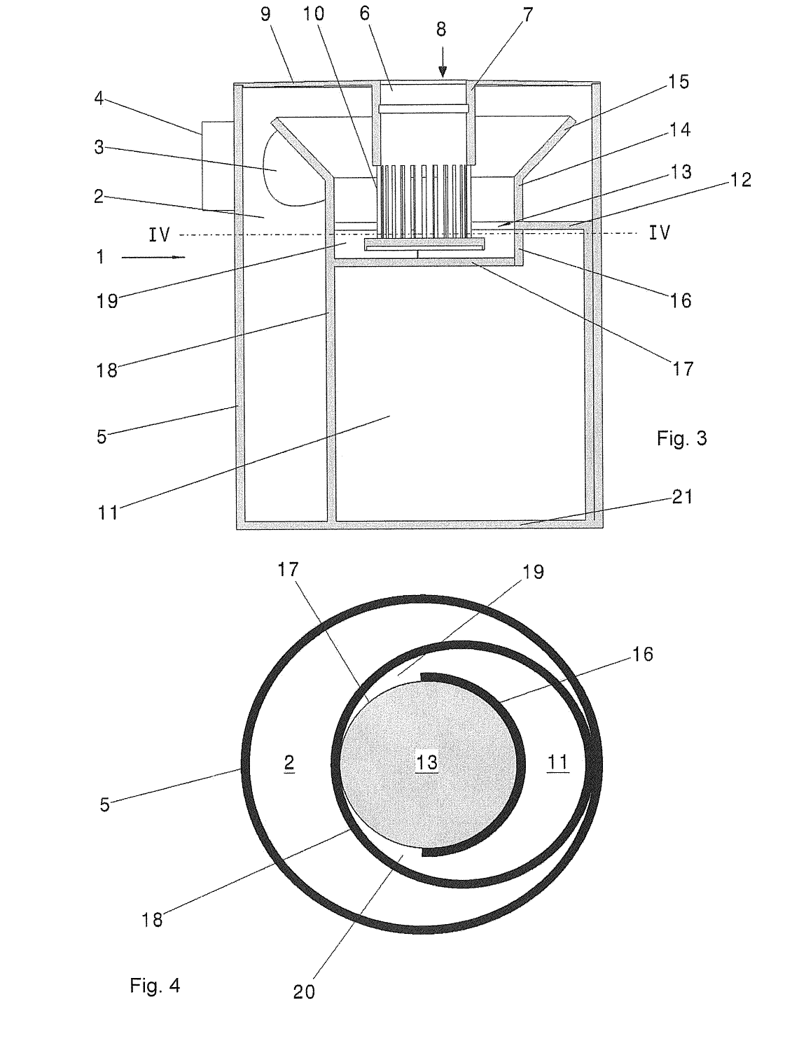

FIG. 3 is a longitudinal cross-sectional view of a dust separation device according to the present invention;

FIG. 4 is a cross-sectional view of the device of FIG. 3, taken along section line IV-IV; and

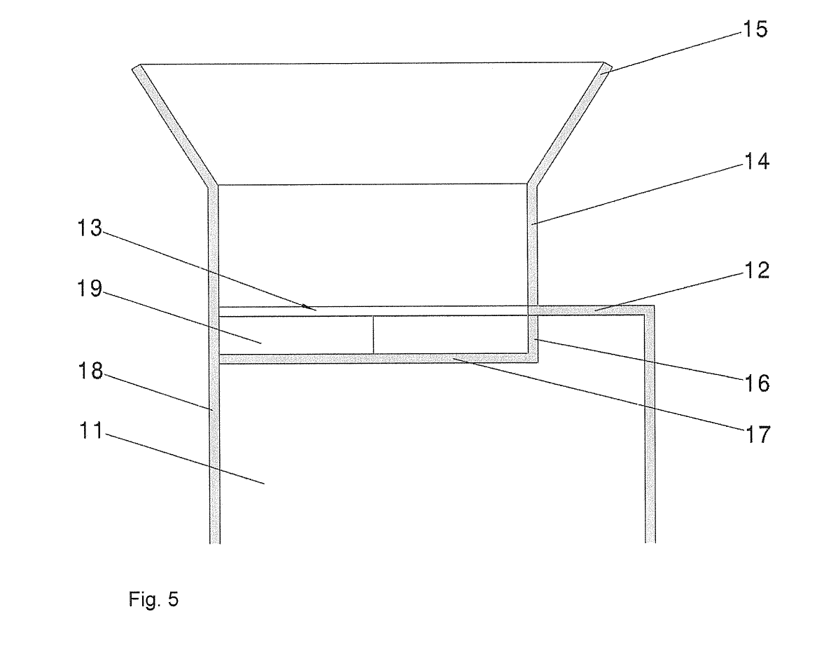

FIG. 5 is a detail view showing the axial separator of the device of FIG. 3.

### DETAILED DESCRIPTION

The tangential separator of the present invention causes the larger particles to be collected in a first container, which can be emptied without stirring up dust. The axial separator provided downstream in the flow path does not need the vanes which are conventionally used to produce swirl, because the swirl is already produced by the tangential separator. It is convenient for the tangential separator to be sized such that a cut size of about 200 μm is obtained for the dust particles. The axial separator should be dimensioned such that a cut size of about 20 μm is obtained for the dust particles.

In an embodiment, the axial separator is free of a swirling device, at least in the region of the air inlet. In this manner, a design is achieved which is easy to manufacture and at the same time prevents hairs and textile fibers from depositing in the air inlet. It is even beneficial if the entire functional portion of the axial separator is free of a swirling device.

The tangential separator and the axial separator should each merge into a dust collection container, from which the dust can be easily removed. For increased ease of use, the dust collection container of the axial separator can be disposed within the dust collection container of the tangential separator, and both containers can be closable by a common bottom.

In an embodiment, the axial separator extends into the dust collection container located therebelow in such a way that the dust particles are swirled within the dust collection container. In this manner, the air is caused to move along a directional path in a swirling pattern, which, firstly, prevents dust and dirt particles from adhering to the container walls and, secondly, allows mixing of said particles with a dust-binding agent. The at least nearly round shape of the second collection container promotes the formation of this vortex. In order to simplify addition of the binding agent, the collection container should be provided with a device for supplying the agent.

The air outlet of the axial separator may be in the form of a dip tube disposed within the tubular section. A screen or grid at the air inlet end prevents dust of the middle fraction from entering the fine dust filter and provides for even flow.

Ease of manufacture is facilitated by forming the dip tube integrally to the upper covering surface of the tangential separator.

Cyclone separators are devices in which at least one component of a mixture is separated by using centrifugal force. To this end, the mixture is supplied through an inlet, set into rotation, whereupon the remainder that is free of the separated component is removed through an outlet. Such separators are used in vacuum cleaners to separate dust and other impurities from the suction air accelerated by a fan.

Simulations and tests surprisingly showed that in an arrangement according to FIG. 2, no vanes (iii) are needed if the flow of air entering the axial separator already has a strong swirl component caused by the upstream tangential separator.

This results in the embodiment shown in FIG. 3. Shown is a device 1 for separating dust from dust-laden, in which an outer container 2 is provided with an off-center air inlet 3. Air inlet 3 widens into a tubular section 4 formed on cylindrical container wall 5. An air outlet 6 takes the form of a dip tube 7 formed on a central opening 8 in container cover 9 and is surrounded by a grid-like flow smoother 10 in the central region of the container. An inner container 11 is disposed eccentrically within outer container 2 and is also provided with an opening 13 in its upper side 12. A tubular section 14 is formed on this opening 13 above the inner container, said tubular section widening into a funnel-shaped collar 15. By arranging inner container 11 and opening 13 eccentrically, it is achieved that tubular section 14 and collar 15 extend coaxially with wall 5 of outer container 2 (see also FIG. 4).

A cylindrical segment 16 is inserted into the opening on the inside of inner container 11 and has a circular bottom 17 formed integrally therewith. Bottom 17 has same radius as opening 13 and, consequently, is in contact with wall 18 of inner container 11 at one side. Cylindrical segment 16 is semicircular in cross-section and extends on the side opposite to the side where bottom 17 contacts wall 18. In this manner, as shown in FIG. 4 and FIG. 5, two openings 19 and 20 are formed, via which the structure formed by collar 15, tubular section 14 and cylindrical segment 16; i.e., the actual axial separator, is fluidically connected to inner container 11.

Containers 2 and 11 can both be emptied by means of a common bottom lid 21.

The following is a description of the operation of the device. The dust-laden air is drawn through air inlet 3 into outer container 2 which, due to the eccentric design, functions as a tangential separator including a dust collection container located therebelow. Here, the coarser and heavier dust particles are already separated at outer wall 5, and finally drop onto bottom lid 21 because of gravity. The air is now only laden with medium and fine dust fractions and is subsequently passed through funnel-shaped collar 15 into the actual axial separator, which is formed by collar 15 and the integrally formed tubular section 14. The upper diameter of collar 15 is selected to be very large so as to keep centrifugal acceleration at a low level. Therefore, only particles greater than 200 pm in size are separated in the tangential separator. Since collar 15 extends into the inlet portion of the tangential separator, the air entering the axial separator has the swirl needed. Therefore, there is no need for vanes (iii) shown in FIG. 2. This, on the one hand, simplifies the overall design and reduces its cost and, on the other hand, makes it less prone to soiling. Funnel-shaped collar 15, because of its continuous taper, delivers all smaller particles to tubular section 14. From there, the air passes through grid-like flow smoother 10 into dip tube 7, and then to a fine dust filter (not shown). The diameter of dip tube 7 defines the cut point of the axial separator on the output side, the dip tube being sized such that particles having a size of up to about 20 μm will be separated from the air stream and caused to fall into inner container 11, which serves as a collection container for the medium dust fraction. This container 11 has a device for supplying a dust-binding agent, which is not shown, but is described in PCT/EP2006/008252, which is hereby incorporated by reference in its entirety.

Grid-like flow smoother 10 fulfills two functions: it smoothes the flow of air entering dip tube 7, thereby improving the separation efficiency of the axial cyclone. In addition, it protects the downstream fine filter. In the event of malfunctions, (e.g., clogged separators, or improperly closed bottom lid 21), relatively large amounts of relatively coarse dust could get into and clog the fine filter. Both functions could also be implemented by a screen structure or a perforated plate. However, the grid structure proposed here is easier to clean, in case fibers get caught in the flow smoother not only during malfunctions, but occasionally also during normal operation. The grid structure may be removable to further increase the ease of cleaning.

In addition to dip tube 7 as an outlet 6 for the air, the axial absorber further has an opening 19 through which the medium dust fraction passes into inner container 11. Located opposite this discharge opening 19 is a second opening 20, which serves as a flow return passage. Via these two openings 19 and 20, the air vortex in the axial separator induces a much weaker secondary vortex in container 11. This secondary vortex ensures efficient mixing of the dust with the dust-binding agent. A round, or at least nearly round, shape of inner container 11 facilitates the formation of the secondary vortex, makes it more uniform, and thus provides for improved mixing. A defined, uniform, substantially horizontal secondary flow is a prerequisite for proper functioning. Too weak an air flow, or an uneven air flow, would result in inadequate mixing, whereas too strong a flow, or a vertical flow, would cause the previously separated particles to be drawn back.

Second opening 20 may be closable. In this case, the above-described secondary vortex will either not form, or a much weaker secondary vortex will form. This is useful in cases where the user wishes to operate the appliance without the dust-binding agent.

The present invention is not limited to the embodiment described herein; reference should be had to the appended claims.

1-12. (canceled)

13. A device for separating dust from dust-laden air, the device comprising:
a tangential cyclone separator having an inlet portion with a tangential inlet; and
an axial cyclone separator disposed downstream of the tangential cyclone separator, the axial cyclone separator having an axial air inlet disposed within the tangential cyclone separator, the axial air inlet including a widening tubular section in a shape of a funnel extending into the inlet portion of the tangential cyclone separator.

14. The device as recited in claim 13, wherein the tangential cyclone separator is configured to provide a cut size of about 200 μm for dust particles.

15. The device as recited in claim 13, wherein the axial cyclone separator is configured to provide a cut size of about 20 μm for dust particles.

16. The device as recited in claim 13, wherein the axial separator is free of a swirling device.

17. The device as recited in claim 13, wherein the axial air-inlet is free of a swirling device.

18. The device as recited in claim 13, wherein each of the tangential separator and the axial separator have a corresponding respective dust collection container.

19. The device as recited in claim 18, wherein the dust collection container corresponding to the axial separator is disposed within the dust collection container corresponding to the tangential separator.

20. The device as recited in claim 19 wherein the dust collection container corresponding to the axial separator and the dust collection container corresponding to the tangential separator have a common bottom.

21. The device as recited in claim 18, wherein the axial separator extends into the corresponding respective dust collection container so as to swirl particles of the dust in a defined manner within the corresponding respective dust collection container.

22. The device as recited in claim 18, wherein the dust collection container corresponding to the axial separator includes a device configured to provide a dust binding agent.

23. The device as recited in claim 13, wherein an air outlet of the axial separator includes a dip tube disposed in the tubular section.

24. The device as recited in claim 23, wherein the dip tube has an air inlet end, and the dip tube is surrounded by a screen at the air inlet end.

25. The device as recited in claim 23, wherein the dip tube has an air inlet end, and the dip tube is surrounded by a grid at the air inlet end.

26. The device as recited in claim 23, wherein the tangential separator includes an upper covering surface, and the dip tube is integral with the upper covering surface.

27. The device as recited in claim 13, wherein the tangential and axial cyclone separators are disposed in a vacuum cleaner.
